(19) United States
(12) Patent Application Publication
(10) Pub. No.: US 2008/0311380 A1
(43) Pub. Date: Dec. 18, 2008

(54) High refractive index materials and composites thereof

(75) Inventor: Anoop Agrawal, Tucson, AZ (US)

Correspondence Address: LAWRENCE R. OREMLAND, P.C., 5055 E. BROADWAY BLVD., SUITE C-214, TUCSON, AZ, 85711, US

(73) Assignee: AJJER LLC, Tucson, AZ (US)

(21) Appl. No.: 12/136,407

(22) Filed: Jun. 10, 2008

Related U.S. Application Data
(60) Provisional application No. 60/934,247, filed on Jun. 12, 2007.

(51) Int. Cl. B32B 5/16

(52) U.S. Cl. 428/323; 428/411.1; 428/688; 428/690

(57) ABSTRACT

This invention discloses composite materials utilizing high refractive index matrices and their use with phosphors and scintillators. Further, the index of refraction difference between the matrix and the particles is less than 0.15.

### RELATED APPLICATION/CLAIM OF PRIORITY

This application is related to and claims priority from Provisional application Ser. No. 60/934,247, filed Jun. 12, 2007, which provisional application is incorporated by reference herein.

### FIELD OF THE INVENTION

The present invention relates to forming high refractive index matrices and use of these in composites formed by particles for optical applications.

### BACKGROUND OF THE INVENTION

In many optical applications composites of materials deliver superior performance. One of the key measures for such composites is their optical clarity. Presence of particles in optical composites can compromise clarity due to the scattering of light. Many of the applications now are increasingly using particles that are of high refractive index, such as phosphors used in displays, lighting and in scintillators to detect ionizing radiation and particles (X-rays, γ-rays, alpha particles, neutrons, electron beams, etc.). To make optically clear composites of these high index particles, matrices are required that match their refractive index. Even when nano-particles are used in a size smaller than the wavelength of light, they can cause scattering when formed as composites, and it is desirable to use index matching as much as possible.

An object of the present invention is to teach how these matrices can be made and used for such optical composites.

### SUMMARY OF THE INVENTION

In accordance with the purposes of the present invention, as embodied and broadly described herein, the present invention provides methods of forming high refractive index matrices and utilizing these to form composites comprising high index particles so that the resulting composites are optically clear.

### BRIEF DESCRIPTION OF THE DRAWINGS

FIG. 1—Comparison of emission from nano-particles and bulk phosphors;

FIG. 2—Optical attenuation vs particle size in composites;

FIG. 3—Functionalization of nano-particles and incorporation in a reactive matrix; and

FIGS. 4a-4c—Schematically shows some examples of the manner in which the high index matrix can be implemented in certain devices, in accordance with the principles of the present invention.

### DETAILED DESCRIPTION

There are several applications where optical composites are required which comprise of particles that are of high index of refraction. Typically high refractive index (RI) is defined as above 1.65. Many light emitting diodes (LEDs) and display applications comprise of phosphors that are embedded in a matrix. Typically these phosphors, e.g., YAG:Ce have a high refractive index (˜1.85) and they are embedded in low RI matrices of refractive index below 1.6 such as silicones. The scattering of light caused by the mismatch results in halos and reduces the color fidelity. Scintillators are used to measure ionizing radiation, and generally, single crystals of scintillating materials are used to detect such radiation. Since this radiation is energetic, the thickness of the crystals can be a fraction of a cm to several 10's of cm. Many of these crystals are mechanically fragile and hygroscopic. Further, growing such large crystals is expensive and are also difficult to shape. An alternative is to use composites comprising particles of scintillating materials in a matrix so that the matrix can provide the necessary protection and the composite may be fabricated (e.g., molded, cast or machined) in any size and shape. However, in order to have thick composites, the refractive index (RI) between the particles and the matrix must match so that the light generated by these particles is not lost due to the scattering from the interface between particles and the matrix. Thus the composites need to be transparent at the emission wavelength of the phosphor that is embeded. Some of the typical scintillators used are listed in Table 1 along with their refractive indices at their maximum emission.

TABLE 1
Various commercial scintillators with their refractive indexes at
the wavelength of maximum emission along with their
thermal expansion [1]

| | Wavelength | | Thermal |
|---|---|---|---|
| Scintillator/ | of max | Refractive index | expansion |
| Phosphor | Emission λₘ, nm | at λₘ | (/C.) × 10⁻⁶ |
| NaI(T1) | 415 | 1.85 | 47.4 |
| CsI(T1) | 550 | 1.79 | 54 |
| CsI(Na) | 420 | 1.84 | 54 |
| CsI(pure) | 315 | 1.95 | 54 |
| BGO | 480 | 2.15 | 7 |
| BaF₂ | 310 | 1.50 | 18.4 |
| CaF₂(Eu) | 435 | 1.47 | 19.5 |
| CdWO₃ | 475 | 2.3 | 10.2 |
| LaCl₃(Ce) | 350 | 1.9 | 11 |
| LaBr₃(Ce) | 380 | 1.9 | 8 |
| Lu_{1.8}Y_{0.2}SiO₅(Ce) | 420 | 1.81 | |
| ZnS(Ag) | 450 | 2.36 | |
| YAG(Ce) | 550 | 1.82 | 80 |
| Gd₂O₂S | 513 to 637 | 2.3 | |
| doped with Tb, | (dopant | | |
| Pr, Eu or others | dependent) | | |

Although “phosphors” and “scintillators” may be used interchangeably to mean the same, however, in the specification, wherever possible for preserving clarity, “phosphors” will be used for those applications where light is directly visualized such as displays and light emitting diodes or other lighting applications, whereas “scintillators” will be used for those systems which are used to detect the ionizing radiation. For displays or LED materials the index matching is less of a problem as compared to the scintillators, as the latter are quite thick in comparison. The thickness of the single crystal scintillators can run into several cm to tens of cm in order to be able to stop the ionizing radiation, and the composites will have to be made in a similar thickness with high optical clarity. In LEDs and displays these may be thinner or shallow encapsulation depths to about fraction of a mm to a few mm. Although the discussion of this invention would be more focused on scintillating materials to demonstrate the invention clearly, but it is equally applicable to phosphors and its applications.

Scintillators are materials that emit light upon absorbing ionizing radiation or energy from ionizing radiation. Radiation detection is essential in applications as diverse as nuclear research, mining, medicine and homeland security. Scintillating materials are the heart of the systems needed to detect radioactive materials that may be transported illegally and improve the long distance detection of nuclear events. Long distance detection of radiation release is essential for determining the location and provides forensics of use or testing of nuclear weapons. The recent threat posed by terrorist organizations who are seeking access to materials for nuclear weapons or radioactive “dirty bombs” make the effectiveness of scintillators a key factor in the war on terror. The detection capabilities of the materials have improved tremendously in the last five years, but more needs to be done to be able to detect radioactive materials that have been hidden, and differentiate dangerous isotopes form those that are routinely transported for peaceful proposes. Current leaders in detector materials are high purity germanium or the newest lanthanum bromide materials. Germanium detectors require cryogenic cooling and lanthanide crystals are expensive to obtain as sufficiently large crystals. Further, such materials are mechanically fragile and highly hygroscopic. The matrices proposed for the composites of this invention may also be used to coat the single scintillating crystals to impart superior resistance to moisture and handling.

Radionuclide detection is unique in that it is the only method to provide absolute proof of fission products from nuclear explosions. The radionuclides from nuclear explosions attach to the dust particles in the atmosphere. To verify an explosion after such an event, the airborne dust particles from the suspected vicinity are captured in air filters including activated charcoal filters. Similarly, underground explosions create radio-active Xenon which is also captured by pumping air through the ground and capturing that on air filters. These filters are then analyzed by equipment where scintillators are used as the heart of the detection system to measure various isotopes of Xenon or other radionuclides. The detection capabilities of the materials have improved tremendously in the last five years, but better tools are needed to be able to detect explosions after longer times have elapsed or which are smaller in size. This will require more sensitive scintillator materials to meet the emerging requirements.

Improved scintillators also benefit research, defense and industrial communities that demonstrate improved capabilities in terms of light output, detection efficiency, high count rate capability, better time resolution of events, and to be able to fabricate them in a variety of sizes and shapes at an attractive price.

Nano-particles of scintillating materials is the new frontier and offer several advantages, in terms of sensitivity and resolution over single crystal analogs, however, it has been difficult to take full advantage of their properties and fabricate useful composite materials using these particles due to reduced optical clarity. Further, many of the limitations in single crystals of high performance scintillators (e.g. lanthanum halides) such as hygroscopicity and mechanical fragility can be overcome by proper composite matrix selection and design. In addition, single crystals are expensive to grow and cannot be easily shaped to fit any desired geometry. Further, scintillator composites also offer the prospects of reduced weight particularly for space applications.

Scintillator composites comprise of particles of scintillating materials in a matrix. The advantage of such a process is the ability to fabricate scintillators in complex shapes and large sizes while taking advantage of the properties of the nano-particles. The major drawback to composite scintillators is their tendency to be optically opaque, making them useable only in a thin film form, limiting their efficiency for detecting neutrons or ionizing radiation. A major source of this opaqueness is a mismatch of optical refractive indices between the materials forming the composite scintillator (e.g., scintillator or phosphor particles and the matrix material). Optical signal from the scintillating particles scatter or reflect at the matrix/particle boundaries and must travel a much greater distance between reaching the edge of the scintillator and exiting, giving them a greater opportunity to be absorbed along the way. As scintillators are made thicker, the optical signal is increasingly attenuated. Further, if the intensity of the pulses is used to discriminate between the gamma rays and neutrons, then this becomes a challenge due to the high signal attenuation within such composites. Thick composites have thicknesses typically greater than 0.1 mm, and may be a meter in thickness.

In order to improve scintillator performance of these composites for either detecting ionizing radiation originating from the radionuclides or thermal neutrons from fission materials, one must improve their optical properties. This invention is directed towards novel matrices that can substantially improve scintillator/phosphor performance by changing their optical characteristics.

There are two methods that may be employed to overcome this issue of opaqueness in composite scintillators. First, where the refractive index of the scintillator particle is matched to that of the matrix and second, where the particle size of the scintillator is reduced to below the light wavelength so that scattering is reduced. As will be discussed below, even when nano-particles of the scintillating materials are made, the opaqueness (or scattering) due to the mismatch of RI is difficult to overcome, particularly with increasing thickness. The objective of this invention is to fabricate matrices with high refractive indices to match the RI of the scintillating materials or phosphors for other applications in order to truly realize the potential of composite systems including those with nano-particles. Table 1 shows that most scintillators/phosphors have their refractive index (RI) between 1.8 and 2. Of the materials listed, ZnS has the highest RI of 2.36.

Composite scintillators where nano-sized phosphor/scintillating particles are encapsulated in a matrix have several advantages. The size of the nano-particles is less then 500 nm, preferably less then 200 nm and most preferably less then 100 nm. Extensive work in composites with scintillating nano-particles has been carried out by Dai et al. [(a) Dai, S., Im, H-J, Pawel, M. D., Composite Solid State Scintillators for Neutron Detection, U.S. Pat. No. 7,105,832 (2006); (b) Dai, S., Stephan, A. C., Brown, S. S., Wallace, S. A., Rondinone, A. J., Composite Scintillators for Detecting Ionizing Radiation, US patent application 2006/0054863 (2006); (c) Keasanli, B., Hong, K., Im, H-J, Dai, S., Highly efficient Solid State Neutron Scintillators Based On Hybrid Sol-gel Nanocomposite Materials, Applied Physics letters, 89, 214014 (2006); (d) Stephan A. C., Dai, S., Wallace, S. A., Miller, L. F., Modeling of Composite Neutron scintillators, Radiation Protection Dosimetry, 116, 165 (2005)]

Although they have not succeeded in making thick high transparency scintillators with high loading of scintillating particles, they have discussed several relevant issues about such scintillating composites through modeling and experimentation. Applicant's approach in this invention overcomes many of the shortcomings in Dai's work.

Typically in neutron scintillator composites, the molecules providing large cross-section such as ⁶Li, ¹⁰B or ¹⁵⁵Gd or ¹⁵⁷Gd or ¹⁴⁹Sm are intimately mixed with the matrix or are part of the matrix. The scintillating nano-particles are then added to make this composite. Dai modeled their system using ⁶Li. When the neutrons interact with the composite, alpha particles are formed due to the neutron and ⁶Li interaction. These alpha particles then travel through the matrix and encounter scintillator particles within this composite, the interaction of which emits light. In their model for the same volume fraction loading, the size of the scintillating materials was varied from 100,000 nm to 100 nm. They concluded that the spread in the energy of the alpha particles observed was much narrower for smaller particles, thus improving the energy resolution. Second, more of the energy from the thermal neutrons was deposited in the composite with smaller scintillating particles.

US Patent applications by Klinov, et. al., (US patent applications 2007/0063208; 2007/0116638 and 2005/0107478), both of which are incorporated herein by reference, describe a process for making composites of nano-particles and combining them with metal alkoxides. They describe classical solgel approach which limits them to thin coatings which are typically processed by spin coating. However, in such systems due to hydrolysis and condensation, the shrinkage is high and it is difficult to form thick objects without cracking. Further, the RI of the matrices in Klinov's work is low and they have not identified this important issue probably because of the low thickness of the coatings used. Klinov discloses methods of making photonic crystals using multiple layers including layers with phosphor nano-particles. Applicant's invention may also be used to form layers of photonic crystals but utilizing higher index matrices.

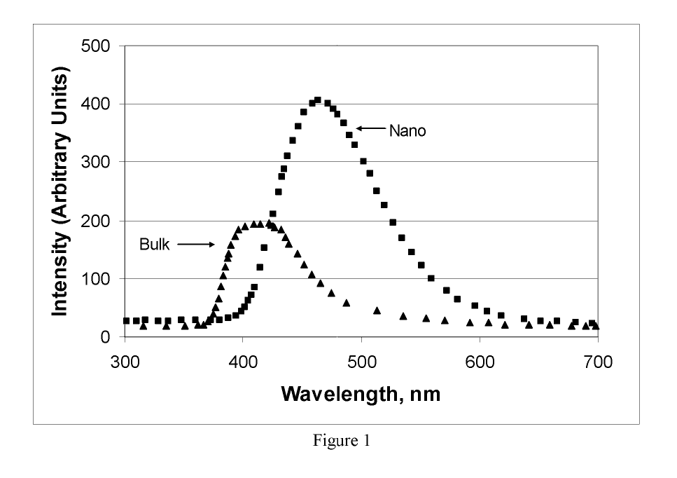

Another advantage of nano-particles is an increase in output intensity over bulk. An example of this is shown in FIG. 1 for 25-100 nm particles are excited by X-ray [see McKigney et al [McKigney, E. A., Del Sesto, R. E., Jacobsohn, L. G., Santi, P. A., Muenchausen, R. E., Ott, K. C., McCleskey, M. T., Bennett, B. L., Smith, J. F., Cooke, D. W., “Nanocomposite scintillators for radiation detection and nuclear spectroscopy, Nuclear Science Symposium Conference Record, IEEE, ISBN 1-4244-0561-0 (2006). Published in Nuclear Instruments and Methods in Physics Research Section A, vol 579, p-15 (2007).]. In addition there may be materials which are difficult to grow in large sizes as single crystals, however, they could be made as particles and then effectively used as useful scintillators by making composites using matched index matrices. Requirements of matching of index between the particle and the matrix is dependent on the size of the particle. These indices need to be closely matched when the particle sizes are large, and this relaxes for smaller particles. Also since many of the crystals are different along the various crystal axes. For large particles scatter can occur from particle surfaces oriented differently even if the RI is matched for one of their orientation, however for smaller particles the matching requirements relax, thus anisotropy is not as important an issue. Further, due to temperature changes the refractive index of the materials change, as the refractive index change is related to the inverse of the thermal expansion (See table 1 for thermal expansion of various scintillators and phosphors). Thus, even for a well matched RI between the particles and the matrix, the change in temperature may create a mismatch of RI due to differential change in expansion. Again for smaller particles due to larger mismatch acceptance, thermal issue is not that important and provides good response over the entire temperature range desired for an application. Although for the purposes of this invention we are not limited by the particle size, it is preferred to have particles sizes smaller than 500 nm, and more preferably smaller than 100 nm and most preferably smaller than 50 nm. The refractive index differential may be any that results in clear composite as long as the matrix RI is higher than 1.65 (high refractive index matrix). However, it is preferred that the RI difference between the particles and the matrix be less than 0.15, and preferably less than 0.02, and most preferably less than 0.005 between the scintillating particles/phosphor and the matrix.

Applicant's approach to making these composites also opens up the field to advantageously use those scintillators that may be prepared as particles but difficult to make in bulk. Nano-particles in any size may be used to make these composites. These matrices may also be used in composites using scintillating/phosphor quantum dots (i.e., the particle size is typically less then 5 nm).

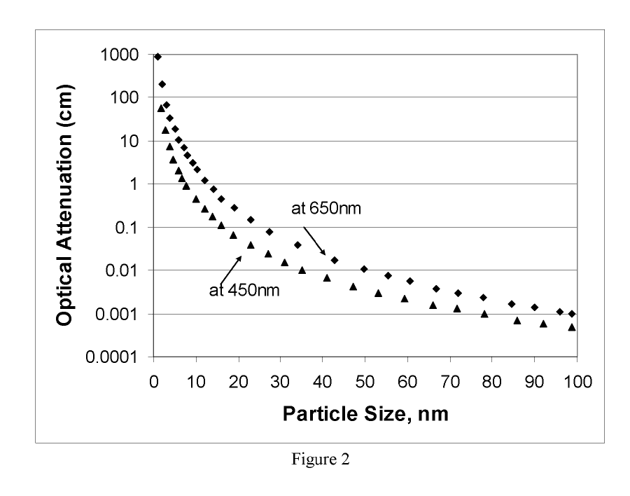

It has been difficult to take advantage of nano-particles of scintillators by forming composites in a matrix. FIG. 2 from a prior art publication (McKigney et al) shows that even if the particles are much smaller than the wavelength of light there is a strong scattering from the index mismatch. This curve is shown for a matrix with an RI of 1.59 and particles with an RI of 1.8. This shows that in order to get high transparency at 50% volume loading and for a composite thickness of 1 mm one has to make these particles below 16 nm for an emission at 450 nm. For 650 nm emission, the size of the particles may be 24 nm or smaller. This plot also shows that for very high attenuation lengths of 10 cm or more at 50% loading and 450 nm emission the particle size will have to be smaller than 2-4 nm. This is an important consideration, as many of the known scintillators/phosphors are semiconductors and their properties are dependent on the band structures resulting from their crystal structures. When the particles start getting smaller than 10 nm, the distortions in the crystal structure could be immense resulting in changed properties. Thus with high RI matrices one could use scintillating/phosphor particles that are larger then about 20 nm and preferably larger then 40 nm. A judicious choice has to be made on the extent of loading, desired composite thickness, emission wavelength and particle size. A preferred loading of the scintillator/phosphor particles is greater than 2% by volume. All of these are dependent on the RI difference between the matrix and the particles, and if the RI is matched many of these restrictions are substantially relaxed dependent on the closeness of this match at the emission wavelength.

Further, from a practical perspective high loadings of small particles while avoiding agglomeration become technologically challenging. Thus, one has to look at means of obtaining transparent scintillator composites where the RI of the matrix can be increased to equal the RI of the particles. As shown in Table 1 most useful scintillators have RI of about 1.8 and higher. Thus, applicant has recognized a need to design matrices with high RI in order to get closer to the particle RI to take advantage of the nano-sized scintillator particles.

Although any method may be used to make high RI matrices for composites of scintillating/phosphor particles, there are two preferred methods. One approach is via the use of organically modified ceramics (OMCs) and the other will use ionic liquids (ILs) or low melting point salts. The purpose of the invention is to demonstrate matrices that are optically clear and have RI of 1.65 or greater at the desired wavelengths. Since for scintillating materials/phosphors the emission is in UV or visible region, the preferred wavelengths are below 700 nm. Several aspects of this invention may also be applicable for high index materials for applications requiring higher wavelengths, particularly those used for communication to about 1560 nm.

In one approach the high refractive matrix comprises of high index non-active nano-particles that are pre-formed and are then uniformly mixed (preferably reacted) with a resin material, so that it results in a refractive index of the matrix between the high index particles and the RI of the resin. Non-active refers to those clear materials or metal oxides, metal nitrides and metal carbides which are not phosphors or do not have scintillating properties for the application at hand. Some examples are oxides of Si, Ti, Zr, Al, Ta, Zn, Sn, Sb, Zr, Be, Ce, Pb, Ge, Bi. One may also use oxides of metals such as undoped Y, Gd and W, as long as they do not interfere with the application (e.g., stop the ionizing radiation and create excessive losses without any desired radiative output). However, when such a matrix is used, the size of the nano-particles of the non-active material must be smaller than that of the phosphor/scintillator particles. In addition, it is preferred that the size of the non-active particles be smaller than about 50 nm. Further, preferably, the volume loading of the non-active particles be smaller then the loading of the phosphor. The optical clarity of the composite for a given thickness in an application will depend on the refractive index difference with that of the resin of the non-active particles and phosphor particles and their sizes. Generally speaking, when the above constraints on the relative loading and particle sizes are used, the particles limiting the optical clarity of the composite are phosphor/scintillator particles and not the high index particles. It is preferred that clear composites be obtained in “high thickness”, i.e., greater than 100 microns. The non-active particles may provide other desirable properties, e.g., electrical conductivity (indium/tin oxide or zinc aluminum oxide or tin antimony oxide), thermal conductivity (e.g., aluminum oxide, aluminum nitride, beryllium oxide) and UV stability (e.g., cerium oxide, zinc oxide).

As an example, Shustack et al (U.S. Patent application 2003/0021566) which is incorporated herein by reference, prepared high refractive index waveguides for telecom wavelengths (1550 nm) by combining nano-particles of ceramics (such as those comprising of titania, zinc and tin of about 20 nm in size) and functionalizing their surfaces so that they may be reacted with acrylics. Their approach was primarily to make thick coatings (˜10 microns thick). Since ceramic particles and organic matrices are combined, these materials are called organically modified ceramics (OMC).

The OMC chemistry could be further modified from Shustack so that the shrinkage is even lower and one can obtain thicker matrices such as from about a mm thick to several 10's of cm thick. Preferred matrices are thermosetting as this allows particles to be mixed in low viscosity resins before solidification.

Dai et. al. in US patent application 2006/0054863 and Klinov et. al. in US patent applications 2007/0063208; 2007/0116638 and 2005/0107478, all of which are incorporated by reference herein, have used a solgel approach to make composites of scintillators with alkoxide precursors. However, they do not discuss the issue of index matching between the particles and the matrix. They also describe making composites using polymeric matrices, but again index matching is not discussed. The use of solgel approach during the casting of the composite is practically suitable for thin coatings and not for getting thick, crack-free bulk samples as solgel processes result in release of small molecules (such as water, ethanol, methanol, etc.) and extensive shrinking. In the OMC approach all such reactions are completed when the particles are still suspended in a liquid medium and before they react with the matrix to form the final composite.

In one approach applicant has modified the principals of OMC to get higher refractive index materials, and also lower the shrinkage so that thick composites in a thickness range exceeding 0.1 mm are obtained. Thick, high refractive index composites may also be used in a fashion where these may be shaped so that they can provide added functionality of a lens in a light emitting diode.

As shown in FIG. 2 (and under the parameters considered) a high transparency matrix with nano-particles with a transparency in a slab of increasing thickness must have smaller nano-particles. These nano-particles maybe formed by subjecting materials to oxidizing plasma at high temperatures, or using solgel precursors such as alkoxides, acetates and nitrates. The latter method is preferred as they are easily functionalized on the surfaces so that they are easy to disperse and to be uniformly incorporated with organic precursors. Further, high index organic precursors are used to knit these nano-particles into a final matrix. Applicant prefers epoxies as organic precursors as these offer lower shrinkage, excellent reactivity control and are available in low and high index materials, so as to be able to cast thick slabs of these with specific RIs. One may also use those monomers (for organic precursors) in part or as a complete substitution that expand on polymerization due to the opening of strained rings. Some of these are spiroorthocarbonates and oxiranes (e.g. see Sadhir et al and Foussier et al; [(a) Sadhir, et al, Expanding Monomers: Synthesis, Characterization, and Applications by Rajender Kumar Sadhir and Mr. Russell M. Luck, CRC, (publishers) (1992); (b) Fouassier et al: Photoinitiation, Photopolymerization, and Photocuring: Fundamentals and Applications, by Jean-Pierre Fouassier, Hanser Gardner (publishers) (1995)]).

Other organic precursors may be used, such as monomers using acrylic chemistry (e.g., acrylates and methacrylates polymerized by UV or heat), urethanes formed by catalyzed reactions of polyols and iscocyanates, or silicones such as those comprising of dimethylsiloxane monomers with unsaturated end groups that may be polymerized using platinum catalysts. The hardness of the final composite will be determined by the organic precursors molecular weight, their flexibility and the density of crosslinks that will be generated. All of these can be tailored to get soft materials with an elastic modulus of about 5 MPa to hard materials with a modulus of 3,000 MPa or above at the use temperature. The use temperature is generally between −40 to about 100° C. Depending on their use these materials may be combined with antioxidants, heat and/or UV stabilizers and flame retardants to prolong their use. UV stabilizers are generally dependent on the organic precursor chosen, but the common ones are benzophenones, benzotriazoles, triazine, hindered amines, etc. Some of the antioxidants are hindered phenols and phosphites. Examples of preferred flame retardants are brominated organics. A more exhaustive list of these can be found in Modern Plastics Encyclopedia and Plastics Technology Buyers Guide. The functionalization of the particles is dependent on the type of monomers/resin used that can react with them. The polymerization schemes may be thermal or radiative polymerization such as using UV, microwaves and Infra-red (IR). Suitable monomers such as epoxy and others may be further halogenated or sulfurized to give higher R's. If the phosphor/scintillator emits in the UV, then UV stabilizer and the matrix must be chosen carefully so that the emitted radiation is not absorbed. In epoxies, cycloaliphatic epoxies have lower UV absorption as compared to aromatic epoxies, but it may come at a cost of reduced RI.

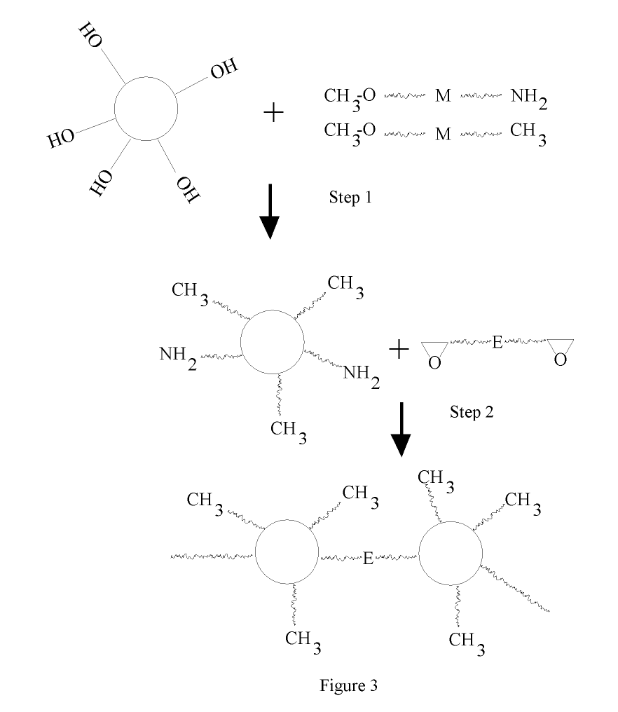

A schematic showing the process of formation of a composite with functionalized nano-particles in an epoxy matrix is shown in FIG. 3. Step 1 shows a nano-particle of high index material as formed which is functionalized using a coupling agent. Several coupling agents may be combined to impart the surface functionalization. These may have different reactivities or even different mechanisms of reaction, or they may be mixtures of reactive and non-reactive (towards matrix resins) agents so that the functionalized particles have a fewer active groups in order to control the nano-particle reactivity with the matrix. These coupling agents may be based on silicon or others such as titanium, aluminum and zirconium. One has to be careful about the amount of reactive groups on the surface of the nano-particles. As these nano-particles can act as centers of hyperbranched structures, and if their loadings are high, the gel point will be reached quickly resulting in poor processability and also poor (more brittle/fragile) mechanical properties. Thus, these may be functionalized using matrix reactive and matrix-nonreactive coupling agents. This will be described in more details using specific examples. Coupling agents such as γ-aminopropyltrimethoxy silane and γ-glycidoxypropyltrimethoxy silane will react with the —OH groups on the surface of the nano-particles at the alkoxy end. The amine or the glycidoxy end is reactive with epoxy and or curing agents used to cure epoxies. Silanes such as isobutyltrimethoxy silane or methyltriethoxy silane will react with the nano-particles but the organic part does not react with the matrix. Thus one may use mixtures of matrix reactive and matrix non-reactive silanes to control the eventual reactivity of the nano-particles. Also, it is preferred that the silanes are reacted with the nano-particles under acidic conditions so that the silyanols so formed do not condense themselves. Functionalized nano-particles are then isolated and dispersed in the resin. The table below gives a selection of brominated epoxy resins from Dow Chemical Co (Midland, Mich.). These have different levels of bromination, and they may be combined with non-brominated resins such as DER 332 and DER330 to tune the refractive index. Some of these resins are solid or in solvents. One may disperse the functionalized nano-particles in the same solvents as the epoxy resins before mixing with the epoxy solutions.

Brominated Epoxy Resines

| | | Epoxide | | |
|---|---|---|---|---|
| | | Equivalent | | |
| | | Weight | Viscosity | Bromine |
| | | (g/eq.) on | (mPa · s @ | Content |
| Epoxy | Description | solids | 25° C.) | (%) |
| D.E.R. ™ | Brominated epoxy resin in acetone | 350-370 | 400-1100 | 16.5-18 |
| 593 | and DOWANOL* PM. | | | |
| D.E.R. 592- | Brominated epoxy resin in acetone. | 350-370 | 1000-2400 | 16.5-18 |
| A80 | | | | |
| D.E.R. 539- | Brominated bisphenol-A type epoxy | 430-470 | 1000-1600 | 19-21 |
| A80 | resin in acetone. | | | |
| D.E.R. 539- | Brominated bisphenol-A type epoxy | 430-470 | 1500-2000 | 19-21 |
| EK80 | resin in methyl ethyl ketone (MEK). | | | |
| D.E.R. 530- | Brominated bisphenol-A type epoxy | 425-440 | 1500-2500 | 19.5-21.5 |
| A80 | resin in acetone. | | | |
| D.E.R.538- | Brominated bisphenol-A type epoxy | 465-495 | 800-1800 | Min. 21% |
| A80 | resin in acetone. | | | |
| D.E.R. | Brominated bisphenol-A epoxy resin | 475-495 | 1250-3000 | 21-22 |
| 514L-EK80 | in methyl ethyl ketone (MEK). | | | |
| D.E.R. 542 | Brominated solid epoxy resin. | 305-355 | 52-62⁾ | 46-51 |
| D.E.R. 560 | Brominated solid epoxy resin. | 440-470 | 78-85⁾ | 47-51 |

Also the solid resins could be mixed with anhydrides (e.g., methyl hexa-hydrophtalic anhydride or nadic methyl anhydride) to give low viscosity matrices with 100% resin content. Further, anhydrides may be catalyzed by imidazoles (available from Air Products (Allentown, Pa.), triphosphine imine, etc. The anhydrides can be made in formulations with long pot life (several hours) so as the processing may be controlled well and then cured at elevated temperature (typically between 100 to 150° C.) in a single step or multiple stages. These composites may be produced at a factory as “A” staged resin sheets with all the ingredients but not fully cured. They may have to be refrigerated in this stage to ensure its properties do not change. When it is decided on the final shape and size, several of these are thawed and assembled together as a unified block in a desired shape and fully cured. The final curing may even be done in a site remote from the factory where “Stage A” sheets are produced. To produce large thicknesses, one may even use processes to keep adding uncured sheets (A staged) and curing them one at a time.

Returning to FIG. 3, amine on the silanes would be the reactive functionality that is shown to react with epoxy groups to form the matrix. In step 2 the functionalized materials are woven in the network. The scintillator/phosphor nano-particles may be functionalized or added and mixed before the curing step, or before gelation of the matrix. For composite neutron scintillators, the proper isotopes such as ⁶Li, ¹⁰B, ¹⁴⁹Sm, ¹⁵⁵Gd, ¹⁵⁷Gd, may be added as salts (nitrates, chlorides and acetates are preferred) or, alkoxides or hydroxides. These may be added at any time as long as they are compatible with the matrix and do not phase separate. These are preferably added prior to or during the functionalization of the non-active or the phosphor particles Alternatively, the non-active particles may be doped with these during their formation.

In the formation of composites all the condensation reactions which result in release of small molecules (water, carbon dioxide, methanol, ethanol, acetic acid, etc) are preferably done in a flask or a reaction vessel before the composite is cured and shaped by reacting with a resin. This keeps the shrinkage low and allows one to form thick composites which are fully dense.

Another route to synthesize high refractive index matrices for composites is to rely on materials with electron rich moieties. This will be explained using a preferred embodiment that results in high RI ionic liquids or low melting point salts (e.g., salts with melting points below 300° C.). Ionic liquids are ionic solvents with melting points close to or below room temperature. Low melting point temperature salts (i.e., melting point lower than 300° C.) result in solid composites (below this temperature) and keeps thermal mismatch stresses low. Those low melting point salts are preferred that solidify by formation glass (amorphous solid) rather than crystallize. Typically the anions and cations of the ILs are large that these do not crystallize and their freezing points are low. Amongst other advantages, usually they do not have a vapor pressure and are non flammable making them useful from an industrial perspective. In a recent publication it was shown that one could make ionic liquids with refractive indices of as high as 2.08 [Deetlefs, et. al. Deetlefs, M., Seddon, K. R., Shara, M., Neotric Optical Media for Refractive Index Determination of Gems and Minerals, New J. Chem, 30, p-317 (2006)] but their use in composites were not described. However, the materials above 1.833 RI were colored. These ionic liquids were based on imidazolium cations and Br⁻ and I⁻ anions and also compound anions formed by mixing bromides and iodides. The ionic liquids present limitless opportunities of blending with other salts and ionic liquids to tailor their RI and also provide a mechanism to add salts of select isotopes of lithium, boron, samarium and gadolinium in order to make these useful for neutron scintillators. Further, the surface of the nano-particles themselves may be functionalized with species that are ionic and have at least an anion or a cation in common with the ionic liquid to make these more compatible. Since, it is not essential for this application that the ionic liquids be liquid at room temperature, we can extend the RI range by synthesizing clear low melting point solids. For example ionic solids with anions such as SnX₆ (where X is Cl or Br) with imidazolium results in high RI. Other preferred anion examples are CX₃CO₂⁻, CX₃SO₃⁻ where at least one of the X is Cl, Br or I and the remainder if any can be alkyl, F or H. Also, to raise the index further, and keep the clarity, the cations may also be made with sulfur, chloride, bromide and iodide moieties. Ionic substances with higher amounts of bromine in the cations can be prepared using standard methodology, for example, N-methyl-4-bromo-pyridinium [Logothetis, et al; Thomas A. Logothetis, Franck Meyer, Pierangelo Metrangolo, Tullio Pilati and Giuseppe Resnati Crystal engineering of brominated tectons: N-methyl-3,5-dibromopyridinum iodide gives particularly short C-BrI halogen bonding, New J. Chem., 28, 760-763 (2004)] or N-methyl-3,5-dibromo-pyridinium [Garcia-Cuadrado et al; Garcia-Cuadrado, Domingo; Cuadro, Ana M.; Alvarez-Builla, Julio; Vaquero, Juan J. Stille reaction on pyridinum cation, Synthetic letters, 11, 1904-1906 (2002)]. These are shown below, where “R” is methyl or it may be changed to another alkyl. Combining brominated anions and cations can lead to materials with high RI. Additives such as stabilizers, antioxidants and fire retardants as discussed above may also be added.

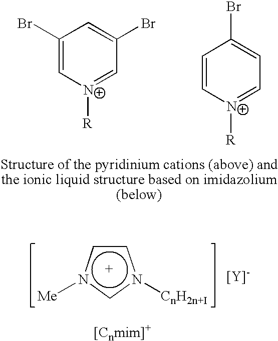

Exact RI match will be obtained by mixing a low RI ionic liquid with that of a high RI ionic liquid. From applicant's work applicant has seen that for ionic liquids to be compatible it is preferable that either one of the anion or cation in the ionic liquids is the same. Thus, as an example, 1hexyl-3-methylimadazolium dibromoiodate has an RI of 1.685 which is miscsible in any proportion with 1ethyl-3-methylimadazolium dibromoiodate with an RI of 1.83. To get a refractive index between 1.685 and 1.830 these may be mixed in appropriate proportions.

The ionic liquids which are liquid at the temperature of use may be used to form liquid matrix scintillators. The nano-particles in the composite may also comprise of non-active nano-particles as discussed above. In case non-active nano-particles are used, then it is preferred that their size and loading be smaller than the phosphors/scintillators as discussed above. These may be poured in any shape containers, degassed and sealed for avoiding any spills. These liquids may also be solidified by adding reactive monomers which polymerize and/or crosslink in situ. Thus the monomer compositions for filling cavities in the invention disclosed here will typically comprise of ionic liquid, nano-particles, and polymerizable monomers. To keep the polymerization caused shrinkage low, it is preferred that the monomer in the composition in the mixture should be less than 25% by weight of the total and more preferably less than 10%. An example may be use of 2-hydroxy ethyl methacrylate (polyHEMA) with ethylene glycol methacrylate as the crosslinker and an appropriate catalyst such as benzoyl peroxide which are all dissolved in the ionic liquid. Then this liquid composition is placed in the cavity and the polymerization is conducted in-situ, e.g., by heating or radiation. Polymers for the preferred ionic liquids of choice are high index as described below. Polymerization/crosslinking may be done using various chemistries. Some of the preferred mechanisms are reactions between amines and epoxies, amines and isocyanates, isocyanates and hydroxyl groups. Addition reactions may be ring opening polymerizations or through the opening of unsaturated bonds and rings. For low shrinkage it is preferred that those monomers be used which have high molecular weight (e.g., functionalized pre-polymers and oligomers), typically greater than 2,500, and preferably greater than 5,000.

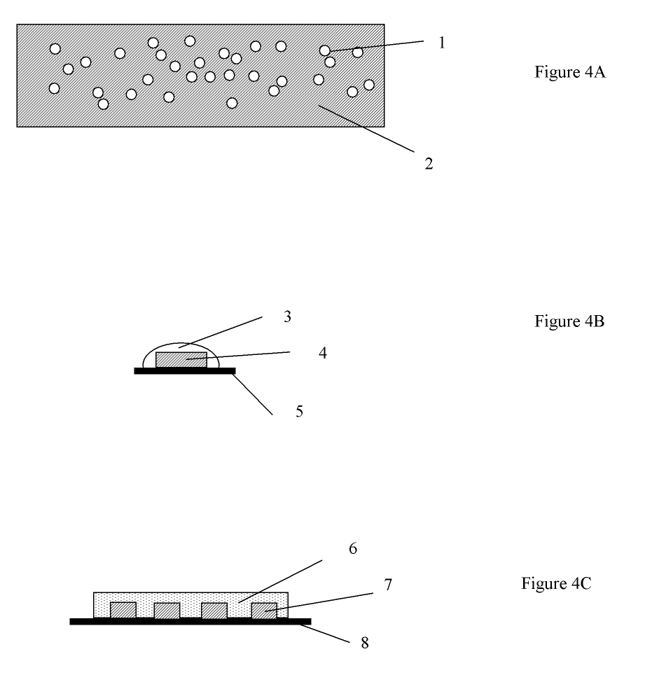

Another way of forming clear solid composites is by the use of those polymers (including copolymers) which result in multi-phase structure, meaning two or more phases. One part of the polymeric chain is readily soluble in the ionic liquid at all temperatures in which the device needs to function, and one other part is insoluble or has low solubility in this temperature range, which forms the second phase. The fall out of the second phase from the solution may result in crystallization of this phase or even a physical or chemical bonding which may require elevated temperature to disperse. Thus, the second phase has a distinct glass transition temperature (Tg) or melting point. As one increases the polymeric content, a viscosity rise is seen, however as the additions continue, suddenly at a particular concentration viscosity rises rapidly and is not measurable. This happens when there is sufficient amount of polymer which is able to form a continuous network of the 2 phase structure, and the domains of the 2nd phase are interconnected by polymer chains compatible with the liquid phase throughout the bulk of the composite body. This is similar to the on-set of gel-point in the formation of crosslinked systems, defined as the first instance when an infinite molecular weight body is first formed. One may use viscosity modifiers in addition to materials that result in formation of a second phase. For 2 phase systems, the present invention contemplates a first phase as the one which is more compatible or well dispersed in the liquid phase, and the subsequent phases, such as second phase being less soluble in the liquid phase. At least one of the subsequent phases keeps parts of the polymeric chains physically locked which results in an overall solidification of the electrolyte. One has to be careful that the formation of multiple phases does not lead to scattering of light. Thus, it is preferred that the size of this phase be smaller then that of the scintillator/phosphor particles and also a refractive index that is similar or lower than these particles. Such systems are more fully described in US patent application US2004/0233537 which is incorporated herein by reference. FIG. 4a shows a schematics of a scintillator material that is formed by a high index material 2 with the scintillator particles being shown as 1.

The use of ionic liquids and low melting point salts to form a solid matrix with high index is novel in itself even if it is not used as a composite with dispersed nano-particles. For example in light emitting diodes and displays one may have to match the RI of the underlying layers such as phosphors, these materials may be used as encapsulants and coatings. FIG. 4b schematic shows an LED 4 on a substrate 5 which is encapsulated with a matrix of high index material 3. This matrix may also be shaped as a lens if desired. FIG. 4c schematic shows a display element comprising of several LED elements 7 on a substrate 8 which are covered with a high index material 6. These high index materials may be used directly or comprise of these materials for use in any optical system where a high index material is required.

The nano-particles, either of the phosphor/scintillator or that of high index particles may be formed by a variety of methods, which include solgel methods or plasma processing methods. Several of the solgel methods are listed by [Yu et al; Taekyung Yu, Jin Joo, Yong Il Park, Taeghwan Hyeon, Large-Scale Nonhydrolytic Sol-Gel Synthesis of Uniform-Sized Ceria Nanocrystals with Spherical, Wire, and Tadpole Shapes Angewandte Chemie International Edition, 44(45), 7411, (2005)], solvothermal processes (also called glycothermal processes), reverse micelles, sonochemical methods, microwave heating methods, thermolysis, non-hydrolytic solgel methods (using halide and non-halide precursors). The particles may have a variety of shapes including spherical, ellipsoidal, dendritic, needle like or flake like. For these nano-particles at least one of the dimensions has to be less then 500 nm, and preferably less than 100 nm.

### EXAMPLE 1

### Preparation of High Index Ionic Liquid

Preparation of 1ethyl-3-methylimadazolium dibromoiodate (with an RI of 1.83) can be prepared from 1ethyl-3-methylimadazolium iodide. Iodoethane is added slowly to 1-methylimidazole at 0° C. in ethanenitrile with constant stirring. After the addition the mixture is slowly brought to room temperature and stirred for two hours. The product is crystallized from the solution by adding ethyl ethanoate, and isolated using filtration followed by washing in ethyl ethanoate. It is dried in vacuum at 80° C. To convert this to the final product, elemental bromine is added to it in the flask with stirring continued for overnight to result in the final product. Since, ionic liquids are difficult to purify after they are made it is important to purify the raw materials before undertaking these reactions, particularly to reduce the colored impurities.

### EXAMPLE 2

### Preparation of High Index OMC Matrix

Some of the preferred high refractive index nano-particle fillers are shown in Table 3. Although a few types of oxide particles are shown, but these could be any oxide, or mixtures of more than one oxide, as long as the RI is suitable for the application at hand. These could be conductive or non-conductive oxides. Some of the conductive oxide nano-particles may comprise antimony, zinc, tin or indium.

TABLE 3

| | | | | | Specific | | | |
|---|---|---|---|---|---|---|---|---|
| | Manufacture/ | | Particle | | surface | Index of | | Oxide |
| Material | Product ID | Dispersion | size | | area | Refraction | pH | (wt %) |
| TiO₂, | Nissan Chemical/ | Methanol | 10-15 | nm | NA | 1.85 | 8.3 | 30.6 |
| ZnO₂, SnO₂ | HX-305M5 | | | | | | | |
| ZrO₂ | Nissan | Aqueous | 4-8 | nm | NA | ~2 | 9-11 | 30-41% |
| | Chemical/Zr30B | | | | | | | |
| | and Zr30BL | | | | | | | |
| ZrO₂ | Nissan | Aqueous | 6-10 | nm | NA | ~2 | 2.5-4.5 | 30-41% |
| | Chemical/Zr30AH | | | | | | | |
| | and Zr30AL | | | | | | | |
| TiO₂ | Sigma | Aqueous | <40 | nm | 20-40 | 2.5 | 2-3 | 5.0 |
| | Aldrich/643114 | | | | m²/g | | | |

NA = Not available, Nissan Chemical America Corp (Houston, TX)

The HX-305M5 dispersed particles are silanol treated which allows dispersion in methanol. They have an average particle size between 10 to 15 nm and an index of refraction of 1.85. The dispersion pH is basic at 8.3 and the loading is high at 30.6% solids. The titanium dioxide dispersion is in water without silanol surface treatment. The particle size is less than 40 nm, the pH is acidic at 2-3 and the loading is low at 5 wt % solids. Examples of other nanoparticles from Degussa (Parsippany, N.J.) are VP zirconium oxide 3-YSZ, VP zirconium Oxide pH, Aero Alu C and Aeroxide® TiO₂ series such as NK960, T805, W2730X, W740X; and from Ishihara Corp USA (San Francisco, Calif.) TTO-55 series, TTO-51(A), TTO-51(C), and Titania Sol TSK-5. The nano-particles of titania may be doped with other metal oxides or be coated with amorphous titania or another oxide such as (aluminum oxide, silicon oxide and zirconium oxide) to reduce its catalytic activity when exposed to UV radiation. Many of the products from Ishihara in TTO-55 and TTO-51 series are coated with aluminum oxide or aluminum and zirconium oxide mixture. TSK-5 titania is coated with silica.

For these particles to be incorporated into the organic epoxy matrix they are functionalized. This is achieved through the use of coupling agents such as silanes, titanates and zirconates. The latter two contain atoms of high refractive index which should help maintain a high index matrix. As an example using a silane based coupling agent the particles can be surface treated to give amino functionality by the addition to the nanoparticle dispersion of 3-aminopropyltrimethoxysilane (97% Sigma Aldrich) and water to enhance hydrolysis. The dispersion is stirred at room temperature for 24 hours. The particles are isolated through the use of a rotary evaporation to remove solvent and the dried powder redispersed in the epoxy monomer medium. Variables here will be the amount of amines on the surface of the particle which will affect its reactivity with the epoxy resin. During treatment those silanes which are non-reactive towards the matrix may be blended to tailor the reactivity of the particles to the matrix. This control is required to allow incorporation of particles in the resin without rapid gelation and or crosslinking. The resin may comprise of the epoxy monomers with curing coming in solely from the surface functional groups on nano-particles that react with the epoxy, or also by adding additional curing agents such as amines (aliphatic or aromatic) and anhydrides.

### EXAMPLE 3

### Preparation of Phosphor/Scintillator High Index Material Particles

Any method may be used to prepare nano-particles of scintillator or the high index materials. One of the preferred methods is by using “Glycothermal Method’ (see Isobe et al[(a) Kasuyra R, Isobe T, Kuma H and Katano J. J. Phys. Chem. B 109, pp 22126, (2005), (b) Isobe T, Low temperature wet chemical syntheses of nanocrystalphosphors with surface modification and their characterization, Phys. Stat. Sol, A, 203, p-2686 (2006), (c) Asakura R. Isobe T. Kurokawa K, Aizawa H and Ohkubo M, Tagging of avidin immobilized beads with biotinylated YAG:Ce³⁺ nanocrystalphosphor, Anal. Bioanal. Chem. 386, p 1641-1647, (2006)]. as it results in particles with hydroxyl groups and are easy to functionalize. Another preferred method is described by Murray et. al. and Qu, et.al [(a) Murray, C. B., Kagan, C. R., Bawendi, M. G., Synthesis and characterization of monodisperse nano-crystals and Close-Packed Nano-crystal Assemblies, Annu. Rev. Mater. Sci, 30 p-545 (2000); (b) Qu, Lianhua, Peng Xiaogang, Control of Photoluminscence Properties of CdSe Nanocrystals in Growth, Journal of American Chemical Society, 124 p-2049 (2002)]. Using “glycothermal method”, YAG: Ce particles are prepared from yttrium (III) acetate tetrahydrate (99.9%), cerium (III) acetate hydrate (99.999%) and aluminum isoproxide (99.99+%) %) in 4-butanediol (>99%) all from Sigma Aldrich (Milwaukee, Wis.) in a pressure reactor at 300° C. while stirring for 2 hours and cooled to room temperature to yield the colloidal solution of YAG:Ce particles of around 10 nm. By heating the reaction for longer periods of time the particle size can be increase due to thermal growth. These colloidal YAG/Ce particles will be functionalized through the addition of 3-aminopropyltrimethoxysilane (97% Sigma Aldrich) and water to enhance hydrolysis. In order the keep the refractive index high a coupling agent other than those based on silicon could be used. Such coupling agents based on titania and zirconium are supplied by Kenrich Petrochemicals of Bayonne N.J. Coupling agents such as alkoxy triacyl titania and di(3-mercapto)propionic zirconate have been demonstrated to help disperse high refractive index nano-particles (Dai et al, (c)). A method to make titania particles this way has been established by Inoue [Inoue, Masashi, Titania and other oxides-Glycothermal synthesis of metal oxides Journal of Physics Condensed Matter, 16(14), S1291 (2004)]

The present invention may be embodied in other specific forms without departing from its spirit or essential characteristics. The described embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

### REFERENCES

Dai et al:
[a] Dai, S., Im, H-J, Pawel, M. D., Composite Solid State Scintillators for Neutron Detection, U.S. Pat. No. 7,105,832 (2006)
[b] Dai, S., Stephan, A. C., Brown, S. S., Wallace, S. A., Rondinone, A. J., Composite Scintillators for Detecting Ionizing Radiation, US patent application 2006/0054863 (2006)
[c] Keasanli, B., Hong, K., Im, H-J, Dai, S., Highly efficient Solid State Neutron Scintillators Based On Hybrid Sol-gel Nanocomposite Materials, Applied Physics letters, 89, 214014 (2006)
[d] Stephan A. C., Dai, S., Wallace, S. A., Miller, L. F., Modeling of Composite Neutron scintillators, Radiation Protection Dosimetry, 116, 165 (2005)
McKigney, et al
McKigney, E. A., Del Sesto, R. E., Jacobsohn, L. G., Santi, P. A., Muenchausen, R. E., Ott, K. C., McCleskey, M. T., Bennett, B. L., Smith, J. F., Cooke, D. W., “Nanocomposite scintillators for radiation detection and nuclear spectroscopy, Nuclear Science Symposium Conference Record, IEEE, ISBN 1-4244-0561-0 (2006). Published in Nuclear Instruments and Methods in Physics Research Section A, vol 579, p-15 (2007).
Sadhir, et al:
Expanding Monomers: Synthesis, Characterization, and Applications by Rajender Kumar Sadhir and Mr. Russell M. Luck, CRC, (publishers) (1992).
Fouassier et al:
Photoinitiation, Photopolymerization, and Photocuring: Fundamentals and Applications, by Jean-Pierre Fouassier, Hanser Gardner (publishers) (1995).
Modern Plastics encylopedia
Modern Plastics Encyclopedia, Year 2001 (published by Chemical Week, NY)
Plastics Technology Buyers Guide
Plastics Technology Buyers Guide, 2006 (Published by Gardner Publication, NY).
Deetlefs, et. al.
Deetlefs, M., Seddon, K. R., Shara, M., Neotric Optical Media for Refractive Index Determination of Gems and Minerals, New J. Chem, 30, p-317 (2006)
Logothetis, et al
Thomas A. Logothetis, Franck Meyer, Pierangelo Metrangolo, Tullio Pilati and Giuseppe Resnati Crystal engineering of brominated tectons: N-methyl-3,5-dibromopyridinium iodide gives particularly short C-BrI halogen bonding, New J. Chem., 28, 760-763 (2004).
Garcia-Cuadrado
Garcia-Cuadrado, Domingo; Cuadro, Ana M.; Alvarez-Builla, Julio; Vaquero, Juan J. Stille reaction on pyridinum cation. Synthetic letters, 11, 1904-1906 (2002).
Inoue
Inoue, Masashi, Titania and other oxides—Glycothermal synthesis of metal oxides Journal of Physics Condensed Matter, 16(14), S1291 (2004)
Isobe, et al:
[a] Kasuyra R. Isobe T. Kuma H and Katano J. J. Phys. Chem. B 109, pp 22126, (2005).
[b] Isobe T. Low temperature wet chemical syntheses of nanocrystalphosphors with surface modification and their characterization, Phys. Stat. Sol, A, 203, p-2686 (2006).
[c] Asakura R. Isobe T. Kurokawa K, Aizawa H and Ohkubo M, Tagging of avidin immobilized beads with biotinylated YAG:Ce³⁺ nanocrystal phosphor, Anal. Bioanal. Chem. 386, p 1641-1647, (2006).
Yu, et al:
Taekyung Yu, Jin Joo, Yong Il Park, Taeghwan Hyeon Large-Scale Nonhydrolytic Sol-Gel Synthesis of Uniform-Sized Ceria Nanocrystals with Spherical, Wire, and Tadpole Shapes Angewandte Chemie International Edition, 44(45), 7411, (2005)
Murray et al
Murray, C. B., Kagan, C. R., Bawendi, M. G., Synthesis and characterization of monodisperse nano-crystals and Close-Packed Nano-crystal Assemblies, Annu. Rev. Mater. Sci, 30 p-545 (2000)
Qu et al
Qu, Lianhua, Peng Xiaogang, Control of Photoluminscence Properties of CdSe Nanocrystals in Growth, Journal of American Chemical Society, 124 p-2049 (2002).
Qu, L., Peng, Z. A., Peng, X, Alternative Routes Toward High Quality CdSe Crystals, Nano Letters, 1 p-333 (2001)

What is claimed is:

1. An optical composite comprising of high refractive index particles dispersed in a medium selected from at least one of high refractive index ionic liquid or a high refractive index low melting point salt.

2. An optical composite comprising of high refractive index particles as in claim 1 where the anion or the cation of the salt or the ionic liquid have at least one of sulfur, chlorine, bromine and iodine moiety.

3. An optical composite comprising of high refractive index particles as in claim 1 where the size of the particles is less then 500 nm, and preferably less then 100 nm.

4. An optical composite comprising of high refractive index particles as in claim 1 wherein the refractive index difference with the particles and the said medium is less than 0.15 and preferably less than 0.02.

5. An optical composite comprising of high refractive index particles as in claim 1 wherein the said particle surfaces are functionalized so as to have a similar anion or a cation to at least one of the ionic liquid or salt in the said medium.

6. An optical composite comprising of high refractive index particles as in claim 1 wherein the particles are of phosphor or scintillating materials.

7. A composite comprising of a high refractive index ionic liquid or salt medium as in claim 6 which further comprises of additional solvents, ionic liquids and salts.

8. A high refractive index ionic liquid or a salt for use in optical composites with the cation comprising of Cl, Br or I moiety.

9. A thick optical composite comprising a high refractive index medium wherein the medium comprises of non-active high-index particles smaller than 100 nm and scintillating/phosphor particles are larger then the said high index particles.

10. A thick optical composite comprising a high refractive index medium as in claim 9, wherein the surface of high index particles or that of phosphor/scintillating materials is functionalized to react with a resin, and that the reaction with the said resin forms the composite.

11. A thick optical composite comprising a high refractive index medium as in claim 10, wherein the said resin is preferably chosen from an epoxy or an expanding monomer.

12. A high index material comprising an ionic liquid or a low temperature melting point salt where it is used in an optical system wherein the RI of the said material is matched to that of the phosphor or a scintillator.

13. A high index material as in claim 11 for use in a light emitting diode package.

14. A high index material as in claim 11 for use in a display.

15. A high index material as in claim 11, wherein it is used in a scintillator package.
